(19) United States
(12) Patent Application Publication
(10) Pub. No.: US 2019/0102724 A1
(43) Pub. Date: Apr. 4, 2019

(54) HIRING DEMAND INDEX

(71) Applicant: Microsoft Technology Licensing, LLC, Redmond, WA (US)

(72) Inventors: Aaron Foss, Sunnyvale, CA (US); Michael Jennings, San Francisco, CA (US); Dan Francis, Belmont, CA (US); Edward Knox, San Francisco, CA (US); Ted Tomlinson, Oakland, CA (US)

(21) Appl. No.: 15/851,299

(22) Filed: Dec. 21, 2017

Related U.S. Application Data
(60) Provisional application No. 62/566,364, filed on Sep. 30, 2017.

(51) Int. Cl. G06Q 10/06; G06Q 10/10; G06Q 50/00

(52) U.S. Cl. CPC G06Q 10/063112; G06Q 50/01; G06Q 10/1053

(57) ABSTRACT

Methods, systems, and computer programs are presented for generating custom hiring metrics based on configurable filters to assist in a company's recruiting efforts. One method includes an operation for determining job metrics, for a global pool of users, that are based on job-post communications received by the global pool. The method further includes operations for receiving filters for generating a report, and for identifying a talent pool based on the filters, which are applied to the global pool based on user profile data. A talent-pool metric is determined based on the job-post communications received by the talent pool, and a hiring demand index (HDI) is determined based on the talent-pool metric and the job metrics for the global pool of users, where the HDI provides a degree of difficulty for hiring users from the talent pool. Further, the report including the HDI for the talent pool is presented.

### CLAIM OF PRIORITY

This application claims priority from U.S. Provisional Patent Application No. 62/566,364, filed Sep. 30, 2017, and entitled “Employer Ranking for Inter-Company Employee Flow.” This provisional application is herein incorporated by reference in its entirety.

### TECHNICAL FIELD

The subject matter disclosed herein generally relates to methods, systems, and programs for providing employment data.

### BACKGROUND

Employment market data is very important for fast growing companies because these companies want to understand employment-related data, such as what the population is for a given skill set, where potential employees are located, what the typical compensation is, whether people for a certain skill are changing jobs often, etc. Further, a good understanding of the labor market may assist a company deciding where to establish a new site because the company may choose a site with a readily-available workforce.

However, employment data is usually kept secret by most companies, which merely provide, sometimes, the number of employees of the company. Therefore, getting a thorough understanding of the labor market based on available skills and geography is a difficult task.

Further, aggregating employment data is particularly difficult since the labor market may vary greatly based on many factors, such as geographic location, employment skills desired, etc. Companies may have certain data based on their difficulties for hiring certain types of employees, but companies may not have access to detailed data, such as how many companies are also searching for the same type of employee, what is the number of potential hires by geographic area, etc.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to some example embodiments, including a social networking server.

FIG. 2A is a screenshot of a user's profile, according to some example embodiments.

FIG. 2B is a screenshot of a user feed that includes items in different categories, according to some example embodiments.

FIG. 3 is a talent pool report, according to some example embodiments.

FIG. 4 is a talent geographic map, according to some example embodiments.

FIG. 5 is a talent-distribution report by company, according to some example embodiments.

FIG. 6 is a talent report by educational institution, according to some example embodiments.

FIG. 7 is a talent report by user skill, according to some example embodiments.

FIG. 8 illustrates the process for calculating the hiring demand index based on the number of received inmails, according to some example embodiments.

FIG. 9 illustrates the process for calculating the hiring demand index based on multiple factors, according to some example embodiments.

FIG. 10 is a workforce-distribution report for a company, according to some example embodiments.

FIG. 11 is a timeline for hires and departures of a given company, according to some example embodiments.

FIG. 12 is a company report by function, according to some example embodiments.

FIG. 13 is a chart showing the evolution of the company score over time for several companies, according to some example embodiments.

FIG. 14 is a report for talent flow between companies, according to some example embodiments.

FIG. 15 illustrates data structures for storing job and member information, according to some example embodiments.

FIG. 16 is a flowchart of a method for generating custom hiring metrics based on configurable filters to assist in a company's recruiting efforts, according to some example embodiments.

FIG. 17 is a block diagram illustrating a representative software architecture, which may be used in conjunction with various hardware architectures herein described.

FIG. 18 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

Example methods, systems, and computer programs are directed to generating custom hiring metrics based on configurable filters to assist in a company's recruiting efforts. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

When a company is hiring a large number of people, such as when opening an office in a new location, it may be important to determine the best place to set the office, and one of the key factors is the availability of workers with the desired skills. If a company chooses a location to open a research and development facility but the engineers to be hired are scarce in that location, the company will face expensive relocation packages and will have to provide incentives to relocate engineers.

It is difficult to determine how easy or difficult it is to hire certain types of employees in a given location. First, companies do not tend to publish information about their employees and a breakdown by skill and function. Second, although there may be many workers available to hire, the demand for these workers may be high, so a company may have to compete with other companies for certain types of talent.

The technical solution to assist hiring managers in making employment-related decisions includes analyzing the supply and demand for workers in order to determine how difficult it is to hire these workers. Further, implementations allow hiring managers to filter the type of employees they are searching and the locations where these employees may be available. Further yet, salary information may be provided to determine how expensive it will be to hire workers.

In some implementations, a hiring demand index (HDI), also referred to herein as hiring difficulty index, is a parameter that measures a level of hiring demand for a specific type of talent in a specific geographic area. The HDI measures the relative difficulty of hiring a specific type of talent compared to the overall difficulty of hiring for the global pool of workers. The HDI may be represented as a number without an upper limit, as a number within a range (e.g., 1 to 100), as belonging to one of several predefined classes (e.g., [very low, low, average, high, very high]), or in any other form, such as a textual description. For example, the HDI measures the degree of interest by recruiters for the selected talent pool. The HDI takes into consideration both the demand and supply sides regarding hiring.

As used herein, the talent pool refers to the workers (e.g., potential employees) in the labor market that meet a defined criteria (e.g., data scientists in Seattle). In some example embodiments, the criteria is defined via configurable filters. The global talent pool refers to all the workers available in the market.

The HDI is valuable to hiring managers for several reasons. The HDI provides an accurate representation of the labor market, and the HDI may be trusted to assist in decision making. Further, the HDI provides a real-time indication of the hiring difficulty, and the calculations are deterministic and explainable (versus other solutions that simply show human-made estimations).

In some implementations, the global talent pool is analyzed to identify the average number of recruiter communications received by users within a predetermined amount of time. The analysis provides a distribution of how many recruiter communications are received per time period. A reporting tool enables a user to select filters for determining the HDI, and the talent pool associated with the selected filters is identified. The average number of recruiter communications received by the users in the talent pool is compared to the distribution of the global talent pool. Based on the comparison, the HDI is calculated, where the HDI indicates how users in the talent pool compare to the global talent pool with regards to recruiter communications.

In other implementations, other metrics may be utilized, besides number of recruiter communications, to calculate the HDI. These metrics may include one or more of number of job posts targeting the talent pool, number of recruiters contacting users in the talent pool, number of companies communicating with the talent pool regarding job posts, a degree of success of a company hiring from the talent pool, salary data for the talent pool, amount of time job posts associated with the talent pool are open, a bid price for job posts targeted to the talent pool, a number of paid job postings targeting the talent pool, and the degree of work mobility for the talent pool.

In one embodiment, a method is provided. The method includes an operation for determining job metrics for a global pool of users, the job metrics being based on job-post communications received by the users in the global pool of users. Further, the method includes an operation for receiving filters for generating a report, the filters being applied to the global pool of users based on user profile data. A talent pool is identified based on the received filters, and a talent-pool metric is the determined based on the job-post communications received by the users in the talent pool. Further, the method includes an operation for determining a hiring demand index based on the talent-pool metric and the job metrics for the global pool of users, the hiring demand index providing a degree of difficulty for hiring users from the talent pool. The method further includes an operation for causing presentation of the report, the report including the hiring demand index for the talent pool.

In another embodiment, a system includes a memory comprising instructions and one or more computer processors. The instructions, when executed by the one or more computer processors, cause the one or more computer processors to perform operations comprising: determining job metrics for a global pool of users, the job metrics being based on job-post communications received by the users in the global pool of users: receiving filters for generating a report, the filters being applied to the global pool of users based on user profile data; identifying a talent pool based on the received filters; determining a talent-pool metric based on the job-post communications received by the users in the talent pool; determining a hiring demand index based on the talent-pool metric and the job metrics for the global pool of users, the hiring demand index providing a degree of difficulty for hiring users from the talent pool; and causing presentation of the report, the report including the hiring demand index for the talent pool.

In yet another embodiment, a non-transitory machine-readable storage medium includes instructions that, when executed by a machine, cause the machine to perform operations comprising: determining job metrics for a global pool of users, the job metrics being based on job-post communications received by the users in the global pool of users; receiving filters for generating a report, the filters being applied to the global pool of users based on user profile data; identifying a talent pool based on the received filters; determining a talent-pool metric based on the job-post communications received by the users in the talent pool; determining a hiring demand index based on the talent-pool metric and the job metrics for the global pool of users, the hiring demand index providing a degree of difficulty) for hiring users from the talent pool; and causing presentation of the report, the report including the hiring demand index for the talent pool.

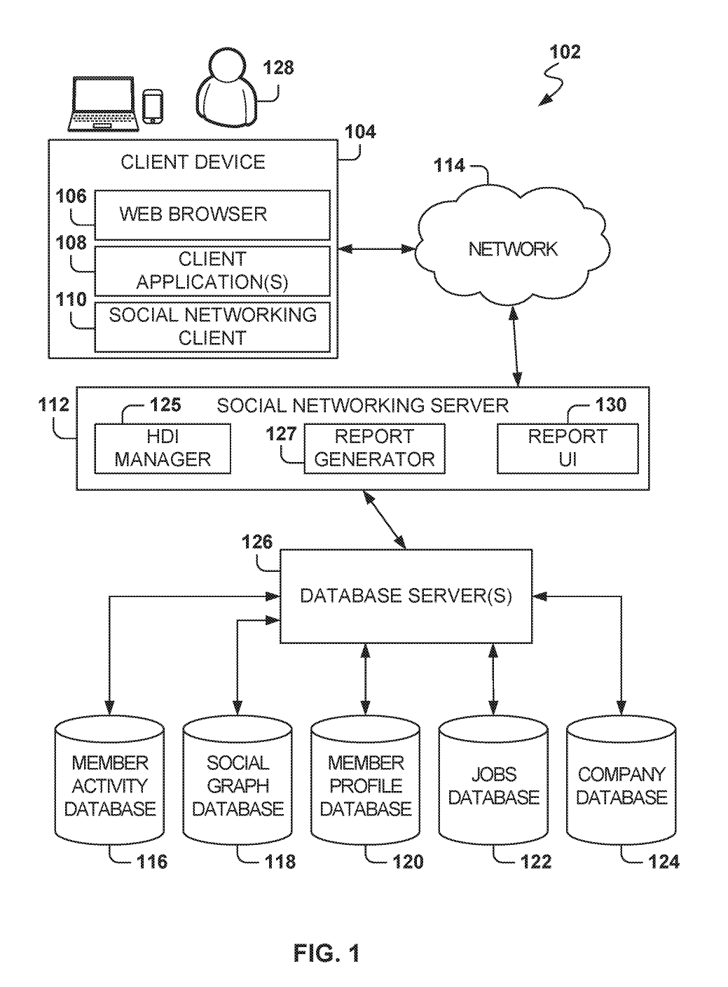

FIG. 1 is a block diagram illustrating a networked system, according to some example embodiments, including a social networking server 112, illustrating an example embodiment of a high-level client-server-based network architecture 102. The social networking server 112 provides server-side functionality via a network 114 (e.g., the Internet or a wide area network (WAN)) to one or more client devices 104. FIG. 1 illustrates, for example, a web browser 106, client application(s) 108, and a social networking client 110 executing on a client device 104. The social networking server 112 is further communicatively coupled with one or more database servers 126 that provide access to one or more databases 116-124.

The client device 104 may comprise, but is not limited to, a mobile phone, a desktop computer, a laptop, a portable digital assistant (PDA), a smart phone, a tablet, a netbook, a multi-processor system, a microprocessor-based or programmable consumer electronic system, or any other communication device that a user 128 may utilize to access the social networking server 112. In some embodiments, the client device 104 may comprise a display module (not shown) to display information (e.g., in the form of user interfaces). In further embodiments, the client device 104 may comprise one or more of touch screens, accelerometers, gyroscopes, cameras, microphones, global positioning system (GPS) devices, and so forth.

In one embodiment, the social networking server 112 is a network-based appliance that responds to initialization requests or search queries from the client device 104. One or more users 128 may be a person, a machine, or other means of interacting with the client device 104. In various embodiments, the user 128 is not part of the network architecture 102, but may interact with the network architecture 102 via the client device 104 or another means.

The client device 104 may include one or more applications (also referred to as “apps”) such as, but not limited to, the web browser 106, the social networking client 110, and other client applications 108, such as a messaging application, an electronic mail (email) application, a news application, and the like. In some embodiments, if the social networking client 110 is present in the client device 104, then the social networking client 110 is configured to locally provide the user interface for the application and to communicate with the social networking server 112, on an as-needed basis, for data and/or processing capabilities not locally available (e.g., to access a member profile, to authenticate a user 128, to identify or locate other connected members, etc.). Conversely, if the social networking client 110 is not included in the client device 104, the client device 104 may use the web browser 106 to access the social networking server 112.

Further, while the client-server-based network architecture 102 is described with reference to a client-server architecture, the present subject matter is of course not limited to such an architecture, and could equally well find application in a distributed, or peer-to-peer, architecture system, for example.

In addition to the client device 104, the social networking server 112 communicates with the one or more database server(s) 126 and database(s) 116-124. In one example embodiment, the social networking server 112 is communicatively coupled to a member activity database 116, a social graph database 118, a member profile database 120, a jobs database 122, and a company database 124. The databases 116-124 may be implemented as one or more types of databases including, but not limited to, a hierarchical database, a relational database, an object-oriented database, one or more flat files, or combinations thereof.

The member profile database 120 stores member profile information about members who have registered with the social networking server 112. With regard to the member profile database 120, the member may include an individual person or an organization, such as a company, a corporation, a nonprofit organization, an educational institution, or other such organizations.

Consistent with some example embodiments, when a user initially registers to become a member of the social networking service provided by the social networking server 112, the user is prompted to provide some personal information, such as name, age (e.g., birth date), gender, interests, contact information, home town, address, spouse's and/or family members' names, educational background (e.g., schools, majors, matriculation and/or graduation dates, etc.), employment history (e.g., companies worked at, periods of employment for the respective jobs, job title), professional industry (also referred to herein simply as “industry”), skills, professional organizations, and so on. This information is stored, for example, in the member profile database 120. Similarly, when a representative of an organization initially registers the organization with the social networking service provided by the social networking server 112, the representative may be prompted to provide certain information about the organization, such as a company industry. This information may be stored, for example, in the member profile database 120. In some embodiments, the profile data may be processed (e.g., in the background or offline) to generate various derived profile data. For example, if a member has provided information about various job titles that the member has held with the same company or different companies, and for how long, this information may be used to infer or derive a member profile attribute indicating the member's overall seniority level, or seniority level within a particular company. In some example embodiments, importing or otherwise accessing data from one or more externally hosted data sources may enhance profile data for both members and organizations. For instance, with companies in particular, financial data may be imported from one or more external data sources, and made part of a company's profile.

In some example embodiments, the company database 124 stores information regarding companies in the member's profile. A company may also be a member; however, some companies may not be members of the social network even though some of the employees of the company may be members of the social network. The company database 124 includes company information, such as name, industry, contact information, website, address, location, geographic scope, and the like.

As users interact with the social networking service provided by the social networking server 112, the social networking server 112 is configured to monitor these interactions. Examples of interactions include, but are not limited to, commenting on posts entered by other members, viewing member profiles, editing or viewing a member's own profile, sharing content outside of the social networking service (e.g., an article provided by an entity other than the social networking server 112), updating a current status, posting content for other members to view and comment on, posting job suggestions for the members, searching job posts, and other such interactions. In one embodiment, records of these interactions are stored in the member activity database 116, which associates interactions made by a member with his or her member profile stored in the member profile database 120. In one example embodiment, the member activity database 116 includes the posts created by the users of the social networking service for presentation on user feeds.

The jobs database 122 includes job postings offered by companies in the company database 124. Each job posting includes job-related information such as any combination of employer, job title, job description, requirements for the job, salary and benefits, geographic location, one or more job skills required, day the job was posted, relocation benefits, and the like.

In one embodiment, the social networking server 112 communicates with the various databases 116-124 through the one or more database server(s) 126. In this regard, the database server(s) 126 provide one or more interfaces and/or services for providing content to, modifying content in, removing content from, or otherwise interacting with the databases 116-124. For example, and without limitation, such interfaces and/or services may include one or more Application Programming Interfaces (APIs), one or more services provided via a Service-Oriented Architecture (SOA), one or more services provided via a Representational State Transfer (REST)-Oriented Architecture (ROA), or combinations thereof.

While the database server(s) 126 is illustrated as a single block, one of ordinary skill in the art will recognize that the database server(s) 126 may include one or more such servers. Accordingly, and in one embodiment, the database server(s) 126 implemented by the social networking service are further configured to communicate with the social networking server 112.

The social networking server 112 includes, among other modules, a HDI manager 125, a report generator 127, and a report user interface 130. The modules may be implemented in hardware, software (e.g., programs), or a combination thereof. The HDI manager 125 calculates the HDI, as described in more detail below. The report generator 127 generates the reports associated with the employment data, and the report user interface 130 provides an interface for accessing the reports and options for the report generation.

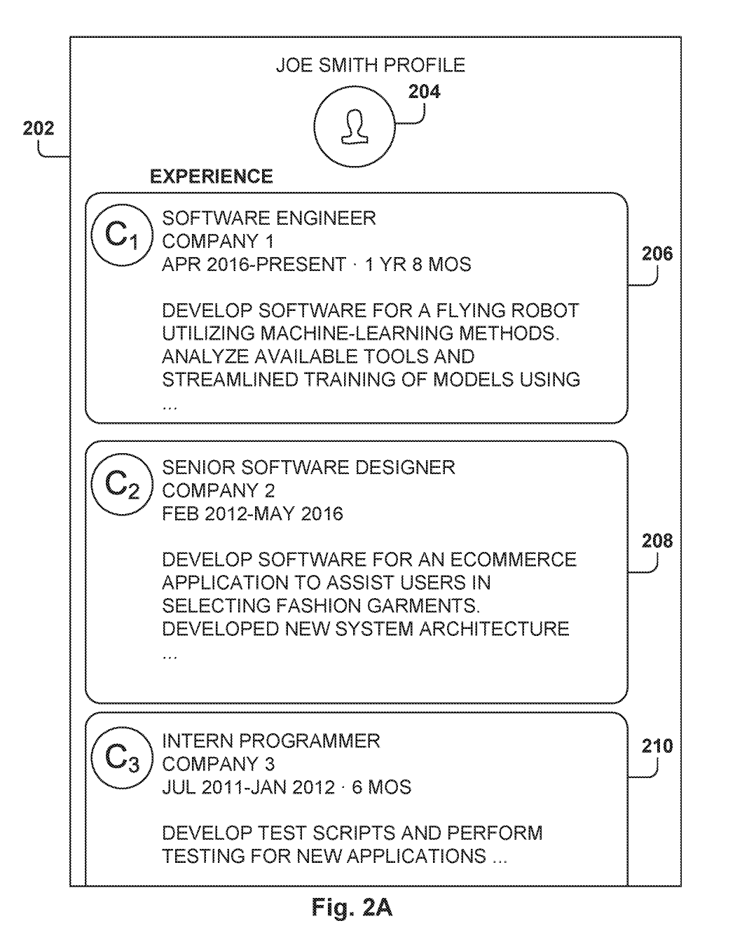

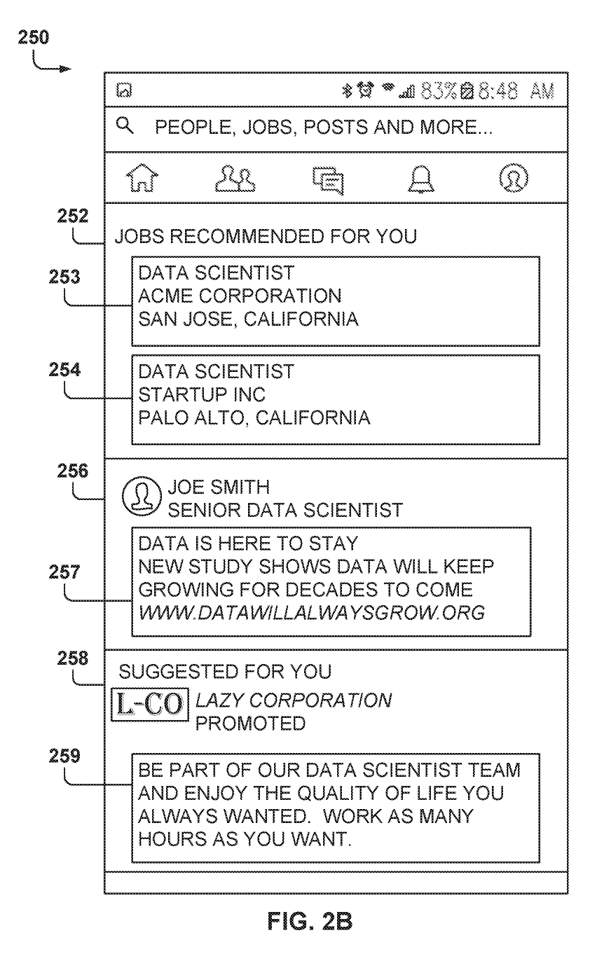

FIG. 2A is a screenshot 202 of a user's profile, according to some example embodiments. In the example embodiment of FIG. 2A, the user's profile includes several jobs held by the user 204, in a format similar to the one used for a resume.

In one example embodiment, each job (206, 208, 210) includes a company logo for the employer (e.g., C₁), a title (e.g., software engineer), the name of the employer (e.g., Company 1), dates of employment, and a description of the job tasks or job responsibilities of the user 204. When users change jobs, the users tend to update their employment history, although updating may not happen right away. By analyzing the job changes, including end date and start dates, it is possible to identify transitions between companies.

The social network analyzes the transitions for the users within the social network and aggregates this transitional data to generate reports based on employee migrations between companies, job titles, job skills, time intervals, etc.

In some example embodiments, the information on the user profiles may be categorized. For example, the company may include a company ID, a title may be assigned a title ID (where the title is standardized to cover a plurality of similar job titles), and a position may be assigned a position ID. In some example embodiments, each job (member_position) of the user may be described utilizing a record with one or more of the following fields: {member_id: int, position_id: int, company_id: int, is_current: boolean (indicating if this is believed to be the user's current job), industry_id: int, position_start_time: long, position_end_time: long}. Other embodiments may include additional fields or fewer fields.

FIG. 2B is a screenshot of a user feed that includes items in different categories, according to some example embodiments. In the example embodiment of FIG. 2B, the user feed 250 includes different categories, such as job recommendations 252, user posts 256, and sponsored items 258, and other embodiments may include additional categories.

In one example embodiment, the social network user interface provides the job recommendations 252 (e.g., job posts 253 and 254) that match the job interests of the user and that are presented with a specific job search request from the user.

The user posts 256 include items 257 posted by users of the social network (e.g., items posted by connections of the user), and may be comments made on the social network, pointers to interesting articles or webpages, etc.

The sponsored items 258 are items 259 placed by sponsors of the social network, which pay a fee for posting those items on user feeds, and may include advertisements or links to webpages that the sponsors want to promote.

Although the categories are shown as separated within the user feed 250, the items from the different categories may be intermixed, and not just be presented as a block. Thus, the user feed 250 may include a large number of items from each of the categories, and the social network decides the order in which these items are presented to the user based on the desired utilities.

Additionally, the user may receive in-network communications from other users. The communications may originate by other users who are socially connected with the user or by unconnected users. One type of communication is an inmail, which is a message sent by a company recruiter to the user. In some example embodiments, the social network provides special access to recruiters for a fee, and the special access includes access to job-related profile data of users (e.g., special searching capabilities) as well as the ability to send this special type of communications (inmails) to the users.

In some example embodiments, the number of inmails received by users are tracked to determine the demand for the skills of the user, such that users that receive more inmails have skills in higher demand than users who receive fewer inmails.

Therefore, the user may receive a message from another user, which is a connection in the social network, asking about the possibility of hiring the user, but these messages are not considered inmails because they are not originated by recruiters.

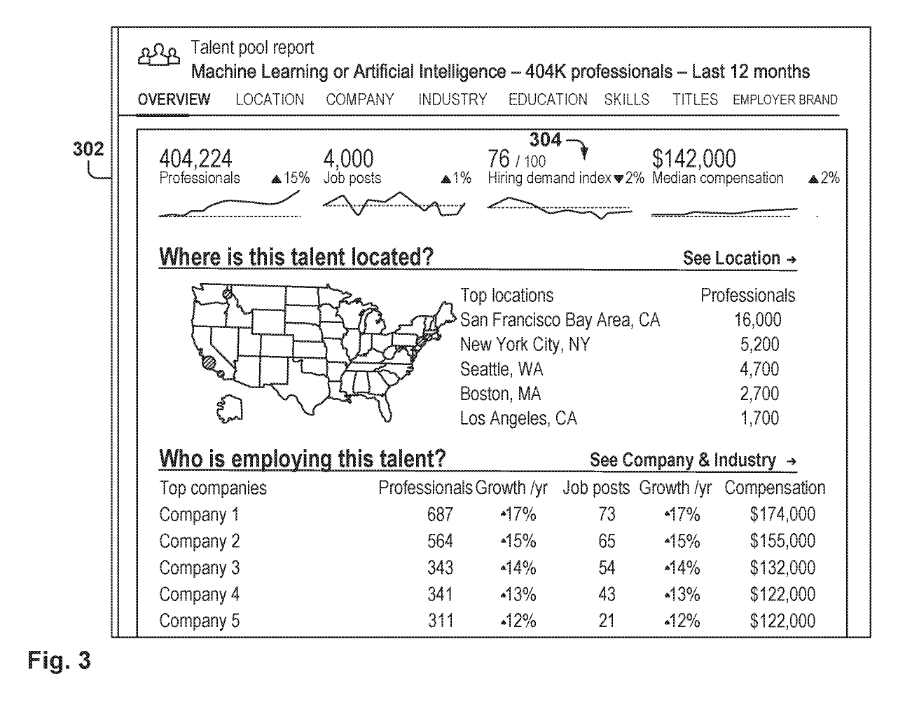

FIG. 3 is a talent pool report 302, according to some example embodiments. The reports provided may include graphical representations in different formats, such as numerical, textual, tabular, or graphical representations of the data. Additionally, multiple report options are available for generating the reports, such as filtering options that may include super-title, geography, time periods, company characteristics, etc. For example, some reports may include the top ten companies by number of employees in a given super-title category, or a predefined number of companies selected by the user, etc.

The generated reports are valuable because they can present information previously unavailable, such as information regarding employee growth rates, attrition rates, HDI, transfer of employees between companies, geographic locations of desired-skills employees, etc. It is noted that most companies do not announce this level of detail for their employees. But by analyzing the social network data, it is possible to get detailed employee statistical data, and because of the data architecture, it is possible to get these reports in real time, without having to scan all the data in the social network every time a report is requested, which could take minutes, hours, or even days.

For example, for a startup company that is not public yet, and that may be operating in “stealth” mode (e.g., sharing little information with the community), it is possible to start finding out that the company is attracting certain types of skills, high-talent workers, growing the employee base at the rapid growth, hiring engineers in some cities and salespeople in other cities, etc. For a financial investor and for a competitor, this type of information may be invaluable since no other financial data may be available to assess the company.

A talent pool report is a type of report that enables finding any population of talent, based on skills, titles, geographies, and industries, while providing insights to help create a talent-acquisition strategy. For example, if the company wants to hire 200 engineers with machine-learning skills, the company may conduct a search to identify where the talent with machine-learning skills is located. This helps the company decide in which locations to hire and establish working teams, or at which locations it will be more expensive to hire employees.

The talent pool report 302 is an example for a super-title of machine learning or artificial intelligence for the last 12 months. The super-title is a value assigned to a group of similar titles. For example, titles such as “software developer,” “application developer,” “programmer,” “software engineer,” “software analyst,” “Java programmer,” etc., may be mapped to a common super-title of “software developer.”

The report 302 indicates that there are 404,224 professionals that match this skill in the geography of interest, the United States in this case. The report 302 further includes numbers and graphical representation of the evolution of the professionals, the number of job posts identified in this period for machine learning, the hiring demand index, and the median compensation (together with respective growth indicators over the previous year). An evolution of the HDI 304 over time (e.g., one year), is shown below the HDI in graphical form, as well as the percentage change over the period of time (e.g., down 2%). In this embodiment, the HDI is defined as a number between zero and 100, and the example shows an HDI 304 of 76.

Additionally, a map of the United States is shown with circles of varying sizes in proportion to the number of employees at the location, for the identified super-title or super-titles. Further, a table shows the tabular representation for the locations and the number of professionals in these locations.

Further yet, the report 302 includes a list of companies (e.g., top five) that are hiring this type of employee and a table is provided indicating, by company, the number of professionals employed at the company, the percentage growth by year, the number of job posts, the growth by each year in the number of job posts, and the median compensation.

For example, the company wants to hire machine-learning engineers, and the company wants to know the relative difficulty to hire that talent in comparison to other type of workers. Further, in a difficult market to hire machine-learning engineers, it is very valuable to identify the relative difficulty by region (e.g., San Francisco Bay area. New York City, Seattle, etc.). This way, the hiring manager may decide what is the best location to establish a team of machine-learning engineers. If the company has the choice of selecting the location, the company may determine in which location to open a new facility based on the difficulty of hiring the desired talent.

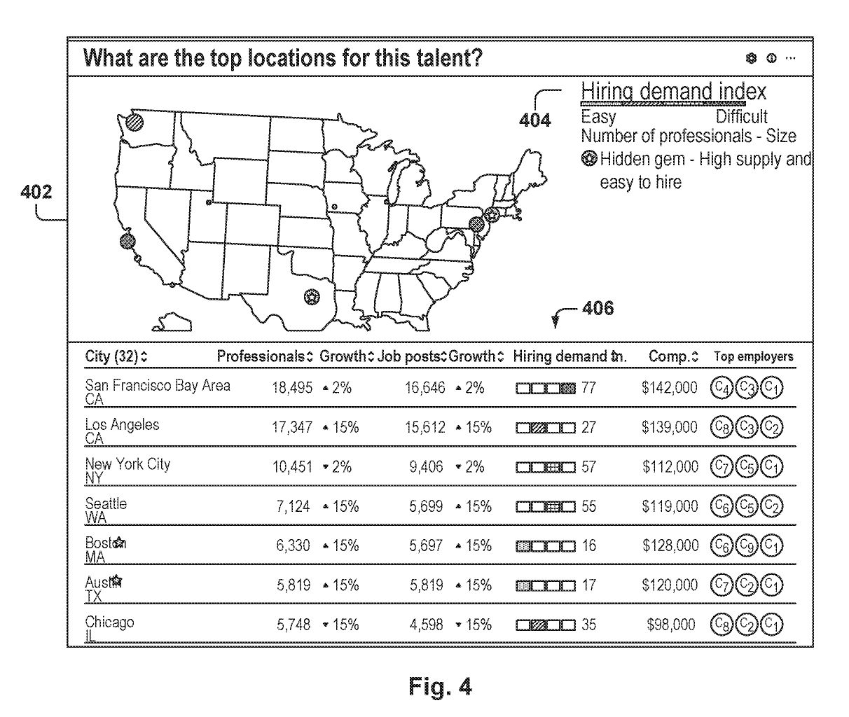

FIG. 4 is a talent geographic map 402, according to some example embodiments. Supply indicates how many employees are available while demand shows how many companies are hiring for the given super-title. By analyzing supply and demand, it is possible to identify geographies where the number of open job positions is much higher than the supply of skilled workers to field those jobs. In this case, there is a shortage, and it will be difficult to hire in that location, or it will be expensive.

In addition, knowing which companies have these workers allows the hiring manager to identify competition for this type of talent. Also, it is possible to see attrition at a company. In this case, employees at this company may be receptive to discussing employment opportunities.

The map 402 illustrates the top locations for this type of talent. The map 402 includes circles that are colored based on the hiring demand index. Thus, there may be some circles indicating where it is difficult to hire, or other circles that indicate “hidden gems” with a large supply of the desired employees.

A table beneath the map 402 shows data by location, indicating the number of professionals in the area, the annual growth in number of professionals, the number of job posts, the growth in job posts, the hiring demand index 406 based on the supply and demand for the region, average compensation, and the top employers in the region (e.g., C₄, C₃, C₁), which may be represented by name, logo, or both.

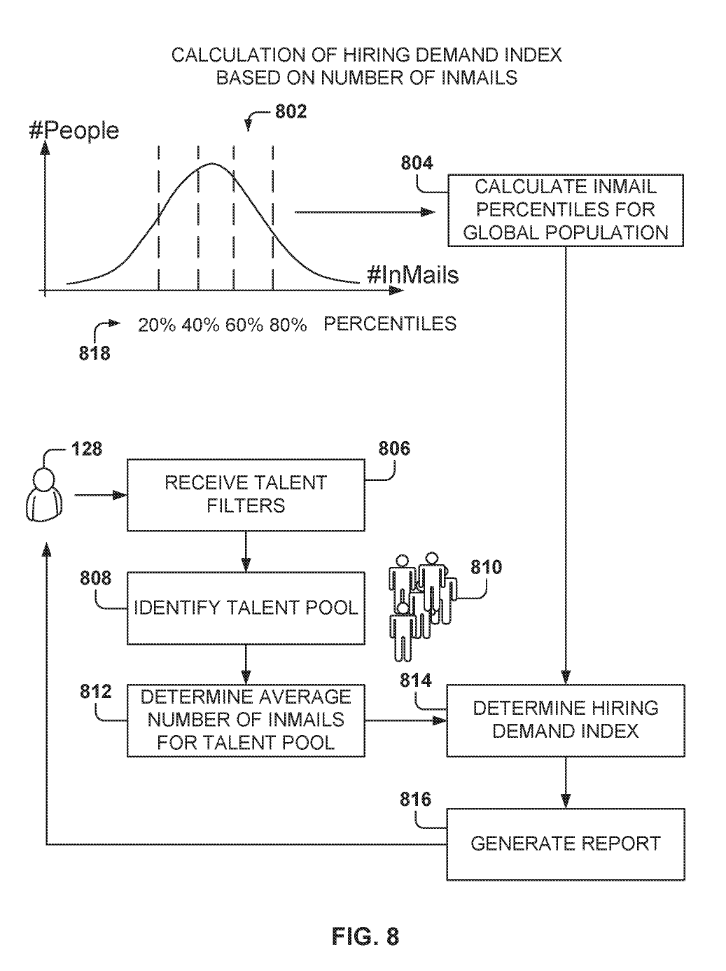

In some example embodiments, the HDI 406 is calculated as the average number of inmails received in a year by the talent pool, and the HDI 406 number is also represented in bands according to the difficulty, growing from easy to difficult, as shown in legend 404. More details about the calculation of the HDI are provided below with reference to FIG. 8.

When calculating the HDI 406 for the different locations, the HDI 406 is calculated as the average number of inmails received in a year for the talent pool in that geographic location. Therefore, the HDI overall for the talent pool may be high, but in some locations the HDI may be low. In the example illustrated in FIG. 4, the HDI 406 is high in San Francisco Bay Area but it is low in Boston and Austin, although the talent pool is larger in San Francisco (18,495) and smaller in Boston and Austin (around 6000).

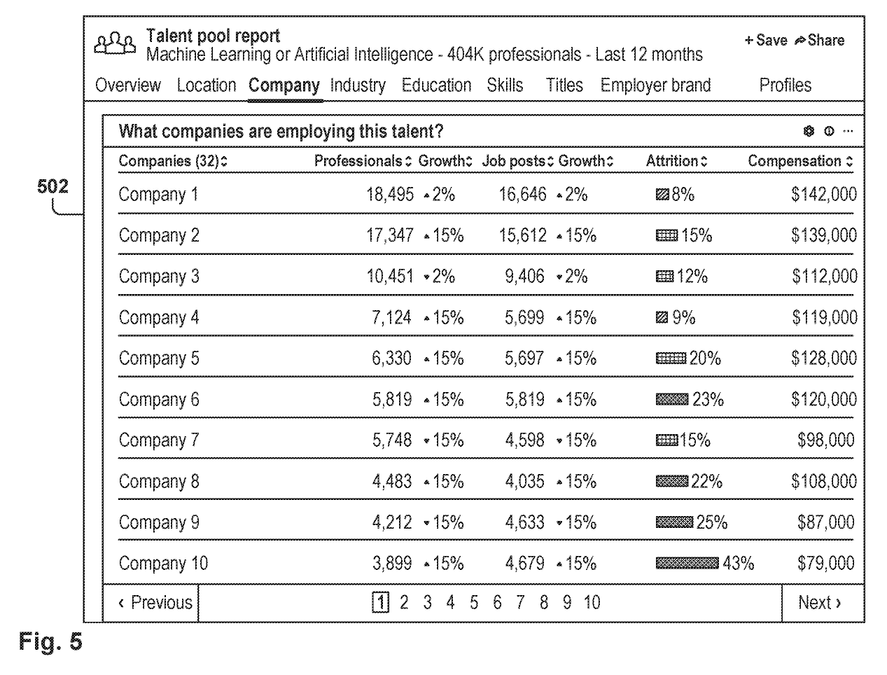

FIG. 5 is a talent-distribution report by company, according to some example embodiments. Chart 502 shows the companies that are employing machine-learning employees. The data is represented in a table, but instead of the HDI, a column with the attrition rate is provided. The attrition rate is represented numerically and as a graphical horizontal bar that is color-coded based on the attrition rate. For example, company 10 has shown a 43% attrition rate over the last year, indicating that the talent is leaving that company.

It is noted that the report includes 32 companies, although only 10 are presented; however, scrolling options are provided in the user interface for showing additional companies.

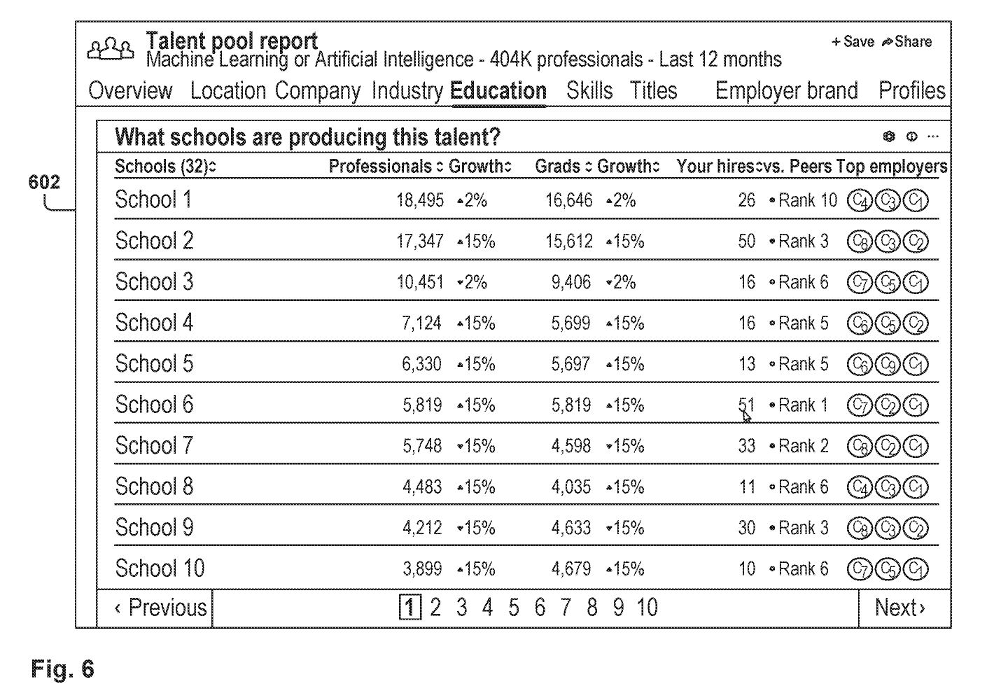

FIG. 6 is a talent report by educational institution, according to some example embodiments. It may also be very informative for a hiring manager to know which schools are providing the desired skills, especially for recent graduates. This way, the hiring manager may intensify hiring activities at the schools generating a large number of graduates with the desired skills.

Chart 602 shows a talent pool report for the schools “producing” this type of talent. The table includes an entry for each school, and each entry includes the number of professionals who show in their profiles that they are graduates from the school, the annual percentage growth in the number of professionals, the number of recent graduates, the annual growth in the number of recent graduates, the number of hires for the company generating the report, ranking versus other peers, and the top employers indicated by their logos, although other embodiments may include their name. Chart 602 includes 10 schools (e.g., universities) and scrolling options are provided to show additional schools.

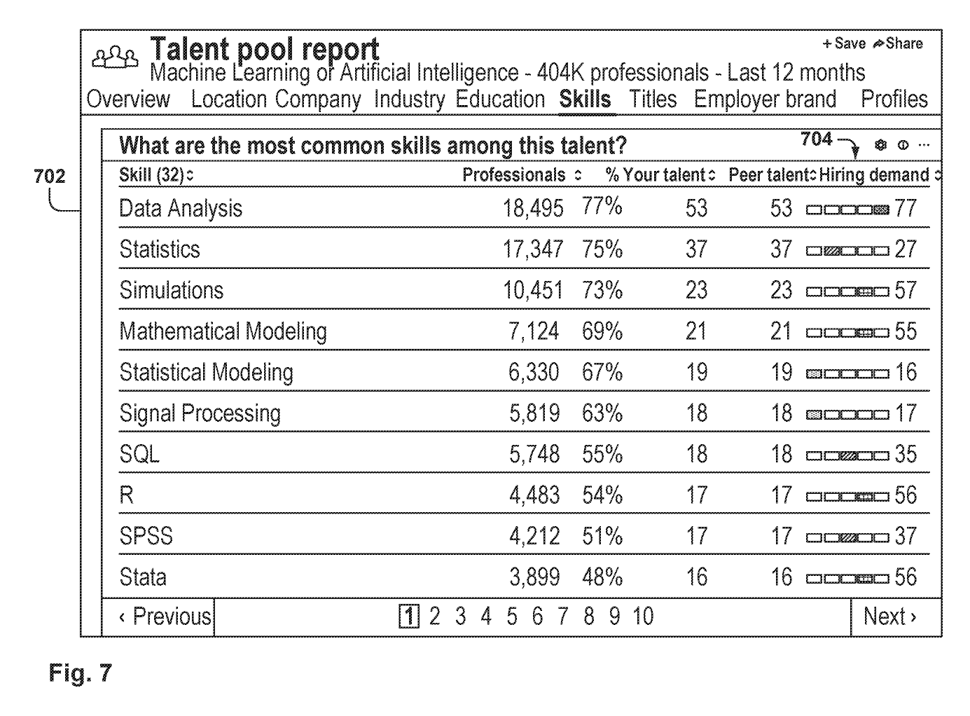

FIG. 7 is a talent report by user skill, according to some example embodiments. Sometimes, it may be difficult to hire the right person for a job, but it may be possible to hire people with similar skills and provide training and mentoring to get the desired skills. Therefore, an analysis of the skills identified by users in the profile may assist in targeting similar types of talent.

Chart 702 represents the most common skills for a given talent (e.g., machine learning or artificial intelligence). The table includes an entry for each skill and is sorted by the number of professionals showing this skill within the target group. For each entry, the number of professionals identifying the skill is shown, as well as the percentage growth in the number of professionals, the number of employees of the present company showing this skill, the number of peers showing this skill, and the HDI for hiring employees that possess this skill.

For example, for machine learning, Data Analysis is identified as the most common skill, followed by Statistics, Simulations, Mathematical Modeling, Statistical Modeling, Signal Processing, etc. The table shows that hiring Data Analysis skills is relatively difficult, with a hiring demand of 77%. However, people with Statistical Modeling and Signal Processing have relatively low hiring demand ratios, so the hiring manager may decide to hire engineers with Statistical Modeling skills and train them to become data scientists.

FIG. 8 illustrates the process for calculating the hiring demand index based on the number of received inmails, according to some example embodiments. In some example embodiments, the HDI is presented as a text label from within five categories: “Very High”, “High”, “Medium”, “Low”. “Very Low”, which correspond to five contiguous non-overlapping ordered intervals over the complete distribution, as shown in the example of FIG. 7.

To calculate (operation 804) the global talent pool's overall HDI, the average number of inmails received per member in the global talent pool is calculated, and that number is compared to global talent pool percentiles 818 (20^{th}, 40^{th}, 60^{th}, and 80^{th}) of the average number of inmails for the talent pool, as illustrated in chart 802. Below is an example of a database query to obtain the percentiles:

```
SELECT
    PERCENTILE20(inmailCountOneYearLookback),
    PERCENTILE40(inmailCountOneYearLookback),
    PERCENTILE60(inmailCountOneYearLookback),
    PERCENTILE80(inmailCountOneYearLookback)
FROM memberProfiles WHERE <talent pool filters>;
```

Table 1 shows an example embodiment for mapping the number of inmails to the HDI tables:

TABLE 1

| Interval | Label |
|---|---|
| [0, 18) | Very Low |
| [18, 30) | Low |
| [30, 41) | Medium |
| [41, 60) | High |
| ≥60 | Very High |

It is noted that other types of communications may be utilized instead of inmails, such as communications regarding job posts, job inquiries, job offers, or any combination thereof. For example, in-network communications sent to members may be scanned (with user consent) to determine which communications relate to job offers, which may be identified by the presence of certain keywords (e.g., job, opening, employment, recruiter, opportunity, etc.), or by other content analysis methods.

In one example embodiment, the database query to obtain the average number of inmails for the talent pools is as follows:

```
SELECT
    AVG(inmailCountOneYearLookback), <other projections>
    FROM memberProfiles WHERE <talent pool filters>
    GROUP BY <module pivot column>;
```

At operation 806, the talent filters are received from the user 128 (e.g., a recruiter or any manager that wants to see a report with the HDI). At operation 808, the talent pool 810 is identified based on the received talent filters by applying these talent filters to the overall population. Thus, the talent pool is a group of individuals that match a given filtering criteria that is applied to the global population.

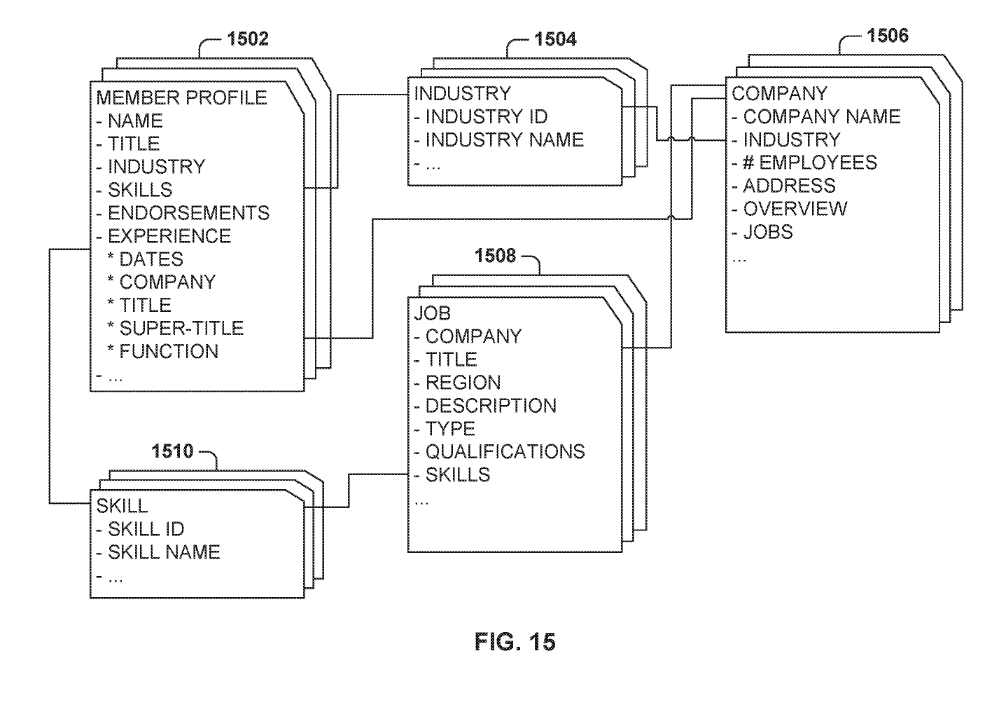

The filters may utilize any information associated with users of the social network, as described in more detail below with reference to FIG. 15. For example, the filters may include any combination of geographic location, skill, title, super-title, years of experience, current company, previous company, education degrees, education institutions, industry, currently searching for a job, unemployed, people following, communications, etc.

At operation 812, the average number of inmails or people in the talent pool is determined, for a certain predetermined period (e.g., six months, a year).

At operation 814, the HDI is determined based on the inmail percentages, calculated at operation 804, and the average number of inmails for the talent pool calculated at operation 812. The average number of inmails is examined to determine the appropriate band and the corresponding band label, as shown above in Table 1.

From operation 814, the method flows to operation 816, where a report is generated that includes the determined HDI. The report is then presented to the user 128.

While the various operations in this flowchart are presented and described sequentially, one of ordinary skill will appreciate that some or all of the operations may be executed in a different order, be combined or omitted, or be executed in parallel.

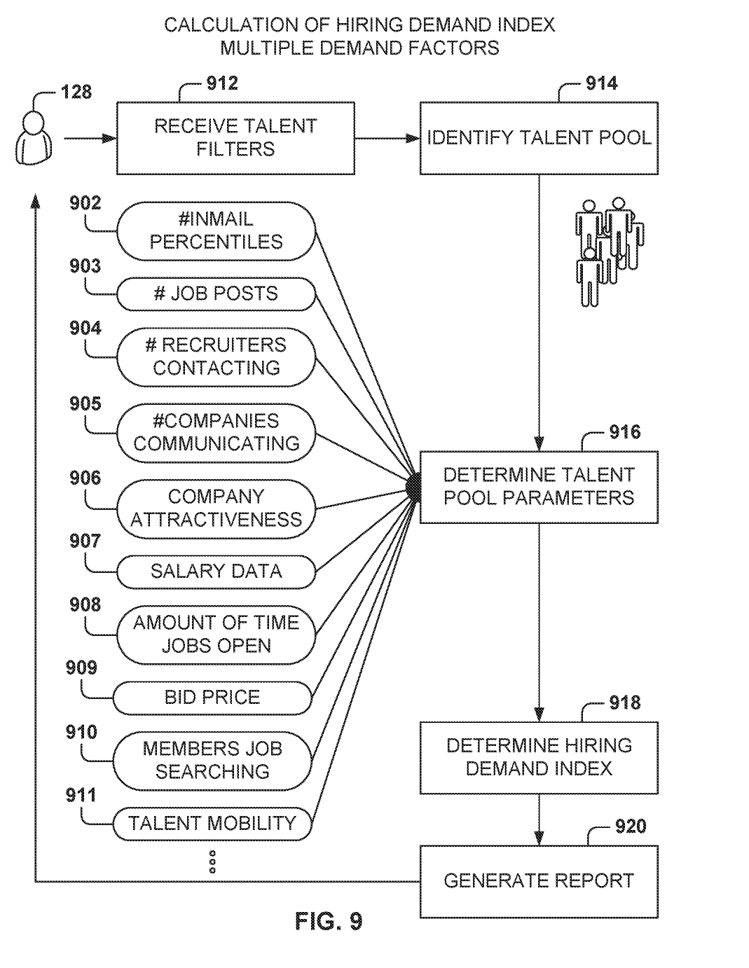

FIG. 9 illustrates the process for calculating the hiring demand index based on multiple factors, according to some example embodiments. In some example embodiments, a plurality of indicators is examined to determine the HDI. The indicators provide information regarding the supply or demand factors for hiring within the talent pool.

At operation 912, the talent filters are received, and at operation 914, the talent pool is identified, as discussed above. At operation 916, the talent pool parameters 902-911 are examined.

The number of job posts 903 that target the talent pool may indicate if the demand is high or low, where the higher number of job posts, the higher the demand. Thus, the higher the number of job posts for the talent pool, the higher the demand. However, job postings may include noise. For example, job posts may be duplicated in different places, such as in the company website or in some other bulletin boards. Therefore, the job posts may be de-duplicated to eliminate repetitions.

Another factor to be considered is that a job post may represent multiple openings. For example, a company that wants to hire 20 software developers may only present a job post for software developer and hire 20 software developers. On the other hand, companies may have a large number of job posts (e.g., thousands), but only a few (e.g., 100) may be active, while the rest may be maintained to capture resumes that may be used in the future or to give the appearance that the company is growing faster than it is.

In some example embodiments, the number of hires of the company is tracked over time and compared to the number of job posts to determine the accuracy of the job posts. The number of hires may be tracked by examining the user profiles of the members of the social network.

Another factor that indicates hiring demand is the number of recruiters 904 contacting members of the talent pool, such that the higher the number of recruiters, the higher the demand. Similarly, the number of companies communicating 905 with the talent pool may be an indication of interest for hiring.

Some companies are able to attract talent more easily than other companies, depending on the reputation of the company, future prospects, social connections, salaries offered, etc. Therefore, company attractiveness 906 may be utilized to determine demand. For example, if a company that has shown difficulty hiring people in the talent pool in the past suddenly starts hiring people from the talent pool with ease, this may be an indication that the demand is going down. Further, if the company with a high degree of attractiveness is hiring from the talent pool, this may not be a strong indicator of demand, since the company may be able to hire independently of the hiring difficulty.

Salary data 907 is another indicator of demand, as the higher the salary, the higher the demand. This means that when a certain type of talent becomes scarce, the salaries will go up. Cost of living must be taken into account when considering salary data 907, because salaries in certain regions are adjusted based on the cost of living in the region. In some example embodiments, the salary data is normalized to eliminate the cost-of-living factor.

The amount of time a job post is open 908 is another indicator of demand, because the easier it is to fill an opening, the lower the demand (or the higher the supply with respect to the demand).

In some example embodiments, for certain types of jobs, a bidding system is implemented, where companies are able to bid on jobs presented to users. For example, a company may pay five dollars per click on a job post presented to members of the talent pool. The bid price 909 is another indicator of demand, as the higher the bid price 909 is, the higher the demand.

In some example embodiments, users of the social network are able to flag in their profiles that they are actively searching for jobs. The number of members in the talent pool actively searching for jobs 910 is another indicator of supply, as the higher the number, the more users are actively searching for jobs, which also means a relatively low demand.

Talent mobility 911 is another demand indicator, as the higher the mobility, the higher the demand. Some types of jobs are filled by individuals that change jobs often (e.g., every year or two), while other jobs are filled by individuals that tend to stay longer (e.g., five years or more). For example, a software developer may change jobs every three or four years, but rocket scientists tend to stay in jobs longer, such as eight years.

By normalizing the supply (e.g., the number of people in the talent pool) by the number of people actually expecting to be changing jobs, it is easier to understand the tendency in the market to hire from the talent pool.

Other talent pool parameters may also be considered, such as the number of companies posting jobs targeting the talent pool and the number of companies targeting media at specific talent pools.

At operation 918, the HDI is calculated based on the talent pool parameters 902-911. The information from the parameters 902-911 may be calculated in different ways. For example, the data from each parameter is normalized, and then a weighted average may be calculated. In other example embodiments, a voting system may take place, where each parameter provides an indication of the demand and the category with the highest number of votes is selected as the HDI. In other example embodiments, the parameters are evaluated to indicate which one would provide a better measurement for the HDI, and the selected parameters are used to calculate the HDI.

At operation 920, the report with the HDI is generated and then presented to the user 128. It is noted that the embodiments illustrated in FIG. 9 are examples and do not describe every possible embodiment. Other embodiments may utilize different indicators, fewer indicators, additional indicators, combine the information in different ways, etc. The embodiments illustrated in FIG. 9 should therefore not be interpreted to be exclusive or limiting, but rather illustrative.

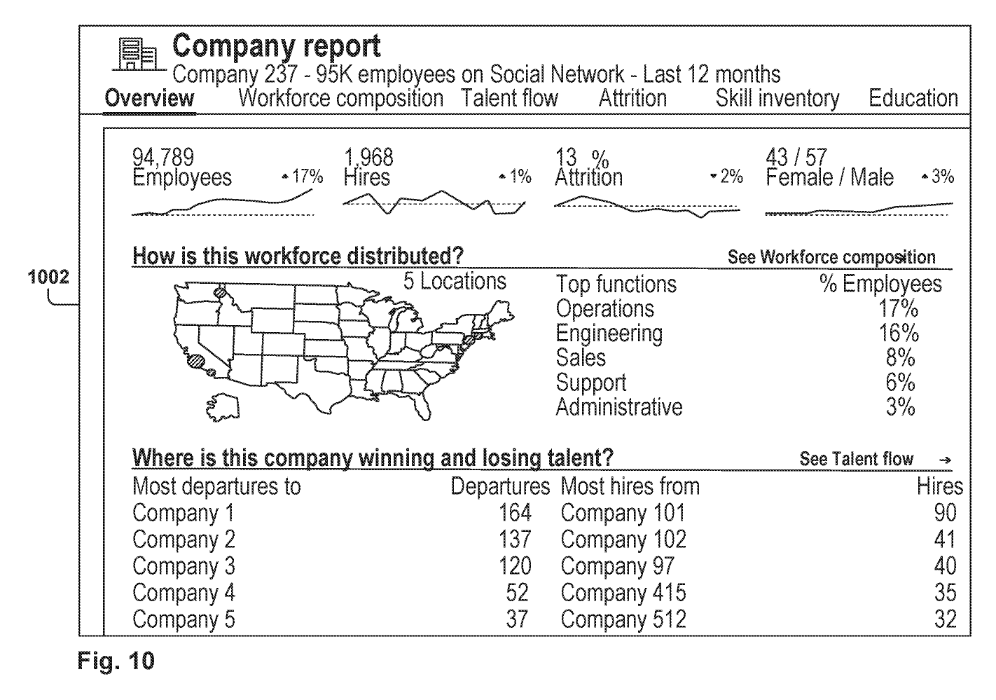

FIG. 10 is a workforce-distribution report for a company, according to some example embodiments. The company report for a particular company (e.g., Company 237 in this example) provides information about the labor composition of the company.

The company report 1002 shows that Company 237 has 94,789 employees with profiles in the social network over the last 12 months. The report 1002 further includes the number of employees, the number of hires, the attrition rate, and the ratio of female to male, with respective linear graphical representations of these values.

Additionally, the company report 1002 shows how the workforce is distributed for this company, illustrated by a map of the United States with circles proportional in size to the concentration of employees. A table next to the map also breaks down the percentage of employees by function, such as Operations, Engineering, Sales, Support, and Administrative.

Further below, a couple of tables indicate where the company is winning and losing talent. A first table on the left shows the companies where employees of Company 237 are going and the number of departures; and a second table on the right shows the companies from which Company 237 is hiring, together with the number of hires within the last 12 months. Company report 1002 provides a dashboard of information for the company as well as some information about competitors for talent.

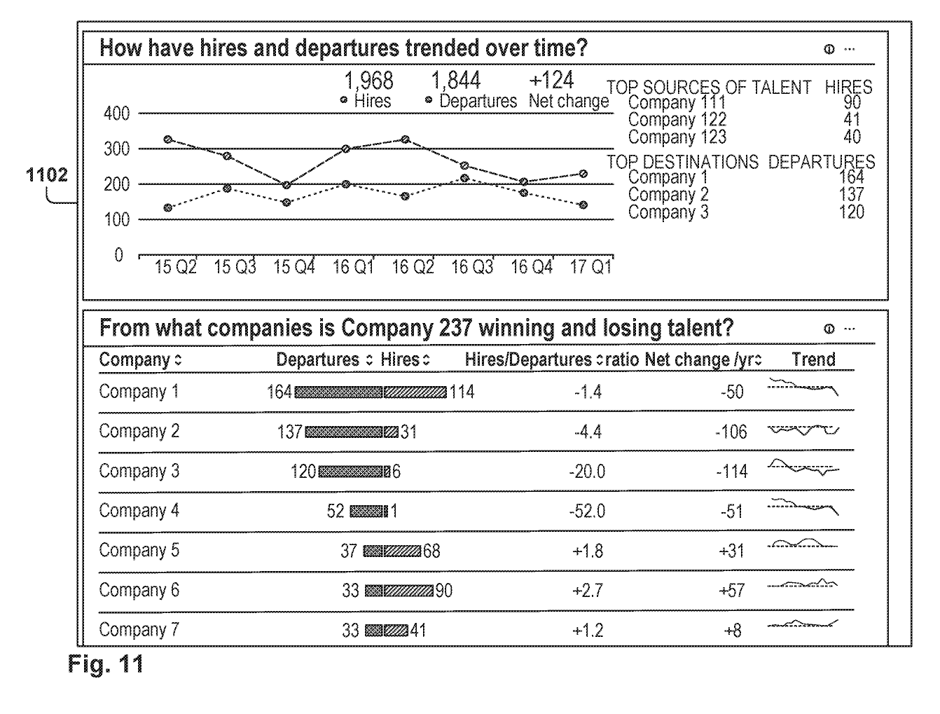

FIG. 11 is a timeline for hires and departures of a given company, according to some example embodiments. Chart 1102 illustrates hires and departure data over time. A top chart shows lines for the number of hires and the number of departures by quarter. Additionally, the companies that are the top sources for talent and the top destinations are shown in tabular form on the right, including the number of hires or departures.

Further, a mixed tabular and graphical summary is presented below to indicate from what companies Company 237 is winning and losing talent. The table includes one entry per company, and for each company a comparison of the departures and hires, a hires-to-departure ratio, a net change per year for hires or departures (color coded: red for losing talent and black for gaining talent), and a historical line showing evolution over time.

The departures-versus-hires column includes a bar with an origin point. The size of the bar grows to the left in proportion to the number of departures and grows to the right in proportion to the number of hires. Additionally, the actual number of departures or hires is shown next to the bar. This is a very useful graphical representation because it is very easy to quickly see how the company is gaining or losing employees to the respective company in the chart. For example, it is clear to see that Company 237 is losing employees to companies 1-4 but gaining employees with reference to companies 5-7.

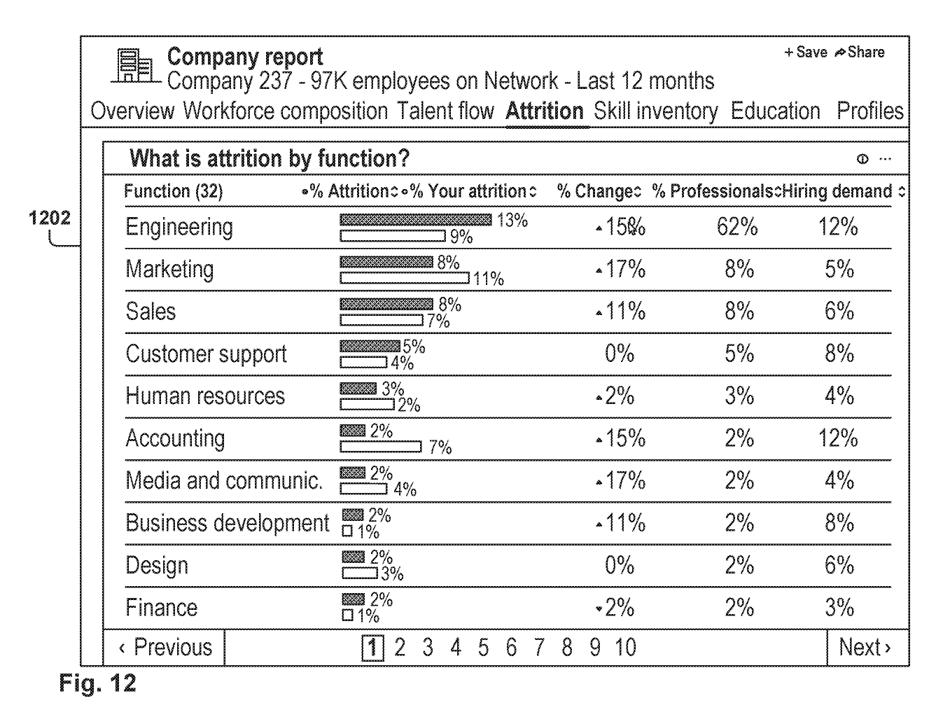

FIG. 12 is a company report by function, according to some example embodiments. Chart 1202 is a company report for a given company (Company 237) that shows the attrition by function. The data is represented in a tabular form with one entry for each of the functions, which include Engineering, Marketing, Sales, Customer support. Human resources, etc.

For each function, two bars are presented: one bar for the attrition rate for the market and another bar for the attrition rate of the company. Other fields include the percentage change in the number of employees, the percentage of professionals within the company, and the hiring demand index for the function.

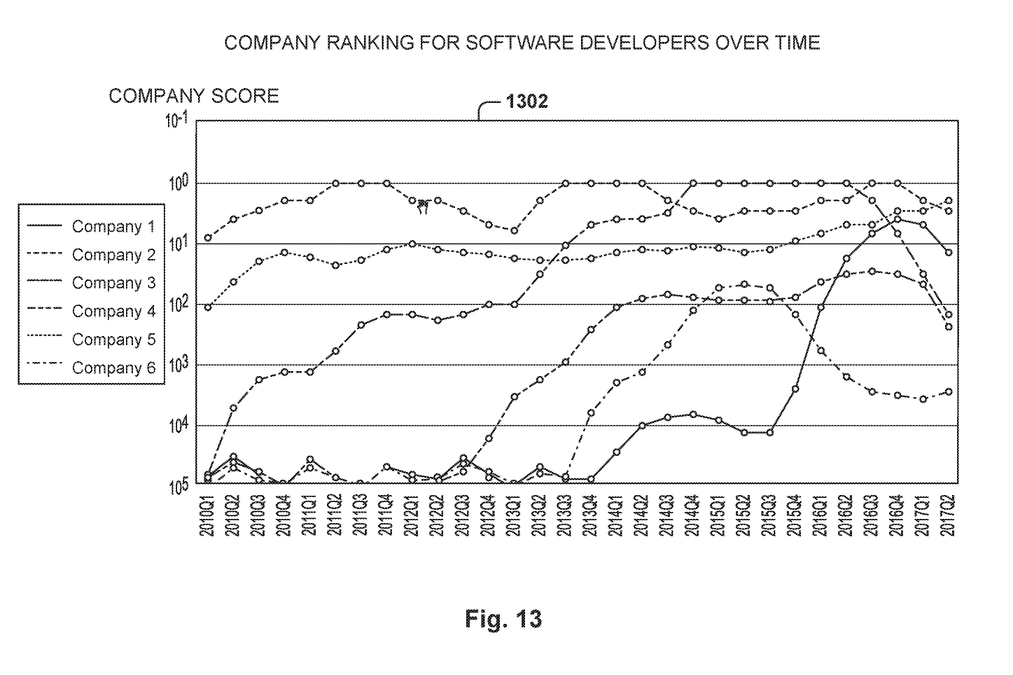

FIG. 13 is a chart 1302 showing the evolution of the company score over time for several companies, according to some example embodiments. Many reports may be generated based on the company scores and the flow of employees between companies. The company score indicates if the company is adding or losing employees and how well the company is able to retain existing employees over time. The company score is a numerical value that measures the performance of a company for hiring and retaining talent. A high company score means that a company is hiring more employees than it is losing and that the company is able to retain employees.

Chart 1302 shows the evolution of the company score, which is a metric indicating if the company is adding or losing employees and how well the company is able to retain existing employees over time. Tracking the company score over time, as illustrated in chart 1302, provides valuable insights into the evolution of a company, because the evolution of the workforce may reflect the financial evolution of the company. For example, companies in financial distress may start terminating employees to save money, and companies in expansion periods may show an increase in the number of employees. A financial analyst may see these trends and decide how to invest or divest from certain companies. This is why the company score may have critical importance for financial investors and company management. Additionally, if a manager identifies that employees are leaving for other companies, the manager may look at the market job trends to increase compensation and be able to retain employees.

In chart 1302, the horizontal axis covers data by quarter, and the vertical axis corresponds to the company score in an inverse logarithmic scale (scores at the bottom are close to 0 and the maximum score is 1).

From chart 1302, the evolution of the companies over time can be easily observed. For example, Company 1 started growing in the fourth quarter of 2013 and saw a very accelerated growth starting at the third quarter of 2015, although it has shown some decrease in the score in the last two quarters. Further, Company 2 has steady growth and thus a high score over the seven years covered in the chart 1302. Company 3 showed gradual growth until it reached the maximum score, but has showed rapid decline over the last four quarters. Company 6 showed rapid growth starting in 2013, but in the third quarter of 2015, the company suffered a large decrease. It is noted that the company score for Company 6 started showing the decline a couple of quarters before Company 6 announced regulatory problems.

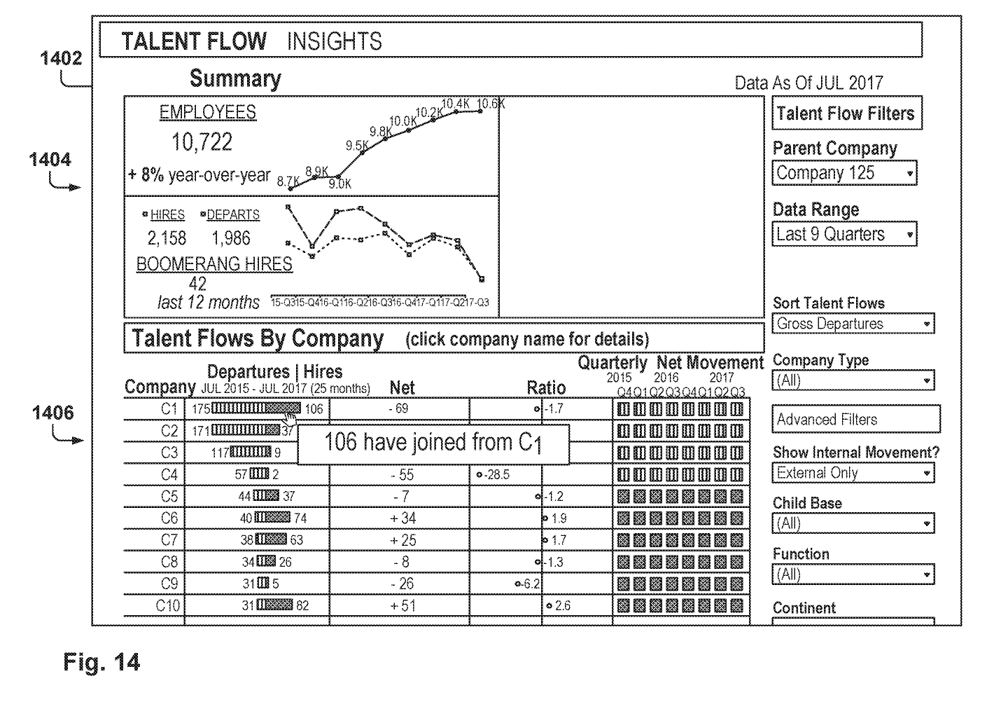

FIG. 14 is a report for talent flow between companies, according to some example embodiments. FIG. 14 provides a dashboard 1402 for talent flow insights. A top section 1404 includes a summary with charts for the number of employees over time, and the number of hires and departures over time. The charts show that the number of employees have steadily grown over time, but that in recent times the numbers of hires and departures are similar, indicating lack of employee growth at the company.

Further, a bottom section 1406 indicates how the talent flows by company. The table includes an entry for each company with hires or departures with respect to Company 237, and includes the double horizontal bar for departures and hires. As shown, if a mouse is placed over the bar, additional information is provided. Other columns indicate the net gain of employees, the ratio between hires and departures, and a color-coded representation of the inflow or outflow, by quarter.

For each quarter, a color-coded square shows an indication of the employee flow. For example, the squares for the first entry, for company C₁, show a prevalent red color, which indicates that the company has been losing employees to company C₁. On the other hand, the squares for company C₁₀ are mainly green, indicating that the company has been gaining talent from C₁₀.

FIG. 15 illustrates data structures for storing job and member information, according to some example embodiments. Each user in the social network has a member profile 1502, which includes information about the user. The member profile 1502 is configurable by the user and includes information about the user and about user activity in the social network (e.g., likes, posts read).

In one example embodiment, the member profile 1502 may include information in several categories, such as experience, education, skills and endorsements, accomplishments, contact information, following, and the like. Skills include professional competences that the member has, and the skills may be added by the member or by other members of the social network. Example skills include C++, Java, Object Programming, Data Mining, Machine Learning, Data Scientist, and the like. Other members of the social network may endorse one or more of the skills and, in some example embodiments, the account is associated with the number of endorsements received for each skill from other members.

The member profile 1502 includes member information, such as name, title (e.g., job title), industry (e.g., legal services), geographic region, jobs, skills and endorsements, and so forth. In some example embodiments, the member profile 1502 also includes job-related data, such as employment history, jobs previously applied to, or jobs already suggested to the member (and how many times the job has been suggested to the member). The experience information includes information related to the professional experience of the user, and may include, for each job, dates, company, title, super-title, functional area, industry, etc. Within the member profile 1502, the skill information is linked to skill data 1510, the employer information is linked to company data 1506, and the industry information is linked to industry data 1504. Other links between tables may be possible.

The skill data 1510 and endorsements includes information about professional skills that the user has identified as having been acquired by the user, and endorsements entered by other users of the social network supporting the skills of the user. Accomplishments include accomplishments entered by the user, and contact information includes contact information for the user, such as email and phone number.

The industry data 1504 is a table for storing the industries identified in the social network. In one example embodiment, the industry data 1504 includes an industry identifier (e.g., a numerical value or a text string), and an industry name, which is a text string associated with the industry (e.g., legal services).

In one example embodiment, the company data 1506 includes company information, such as company name, industry associated with the company, number of employees, address, overview description of the company, job postings, and the like. In some example embodiments, the industry is linked to the industry data 1504.

The skill data 1510 is a table for storing the different skills identified in the social network. In one example embodiment, the skill data 1510 includes a skill identifier (ID) (e.g., a numerical value or a text string) and a name for the skill. The skill identifier may be linked to the member profile 1502 and job data 1508.

In one example embodiment, job data 1508 includes data for jobs posted by companies in the social network. The job data 1508 includes one or more of a title associated with the job (e.g., software developer), a company that posted the job, a geographic region for the job, a description of the job, a type of job, qualifications required for the job, and one or more skills. The job data 1508 may be linked to the company data 1506 and the skill data 1510.

In some example embodiments, features from the member profiles may be used to calculate the HDI, based on the features of the user and the features of other users having some common characteristic with the user (e.g., same talent pool).

It is noted that the embodiments illustrated in FIG. 15 are examples and do not describe every possible embodiment. Other embodiments may utilize different data structures, fewer data structures, combine the information from two data structures into one, add additional or fewer links among the data structures, and the like. The embodiments illustrated in FIG. 15 should therefore not be interpreted to be exclusive or limiting, but rather illustrative.

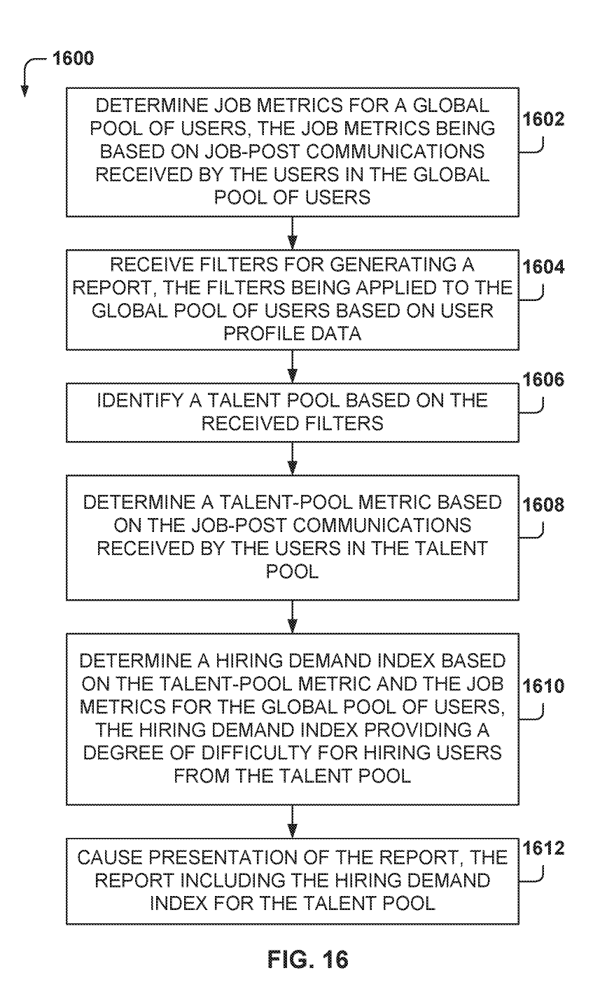

FIG. 16 is a flowchart of a method 1600 for generating custom hiring metrics based on configurable filters to assist in a company's recruiting efforts, according to some example embodiments. While the various operations in this flowchart are presented and described sequentially, one of ordinary skill will appreciate that some or all of the operations may be executed in a different order, be combined or omitted, or be executed in parallel.

At operation 1602, one or more processors determined job metrics for a global pool of users. The job metrics are based on job-post communications received by the users in the global pool of users.

From operation 1602, the method 1600 flows to operation 1604 for receiving, by the one or more processors, filters for generating a report. The filters are applied to the global pool of users based on user profile data.

At operation 1606, the one or more processors identify a talent pool based on the received filters, and at operation 1608, the one or more processors determine a talent-pool metric based on the job-post communications received by the users in the talent pool.

From operation 1608, the method 1600 flows to operation 1610 for determining, by the one or more processors, a hiring demand index based on the talent-pool metric and the job metrics for the global pool of users. The hiring demand index provides a degree of difficulty for hiring users from the talent pool.

From operation 1610, the method 1600 flows to operation 1612 for causing, by the one or more processors, presentation of the report, the report including the hiring demand index for the talent pool.

In one example, the job metrics comprise a number of communications received from recruiters by the user regarding job posts.

In one example, the job metrics are selected from a group comprising number of communications received from recruiters, number of job posts associated with talent pool, number of recruiters contacting users in the talent pool, and number of companies communicating with the talent pool regarding job posts.

In one example, the job metrics are selected from a group comprising a degree of success of a company in hiring from the talent pool, salary data for the talent pool, amount of time job posts associated with the talent pool are open, a bid price for job posts targeted to the talent pool, and a number of paid job postings targeting the talent pool.

In one example, the talent-pool metric comprises an average number of communications received by users in the talent pool, within a predetermined time period, regarding job posts.

In one example, determining the job metrics further comprises calculating percentiles for a number of communications received from recruiters by a user regarding job posts, and determining a plurality of classes based on the percentiles.

In one example, the talent-pool metric is an average number of communications received, within a predetermined time period, by users in the talent pool regarding job posts, and determining the hiring demand index further comprises selecting a class from the plurality of classes based on the talent-pool metric.

In one example, the filters include one or more of a geographic location and a job skill.

In one example, the report includes a number of users in the talent pool based on the filters, a number of job posts targeted to the talent pool, geographic information about the talent pool, and the hiring demand index.

In one example, the job metrics comprise a number of communications received by a user regarding job posts.

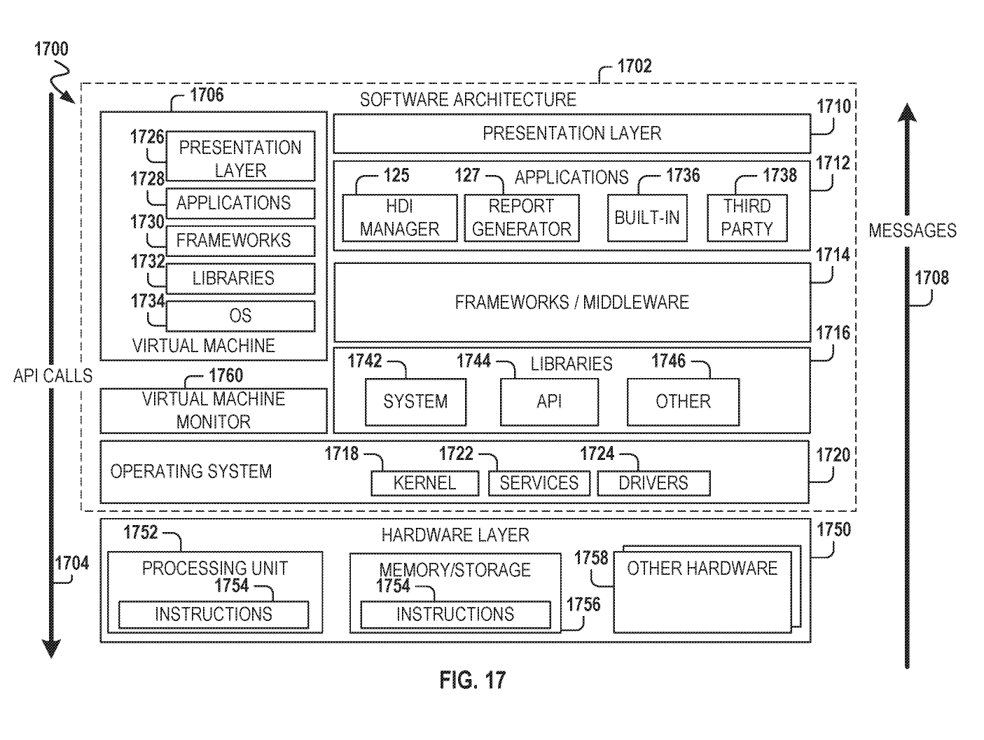

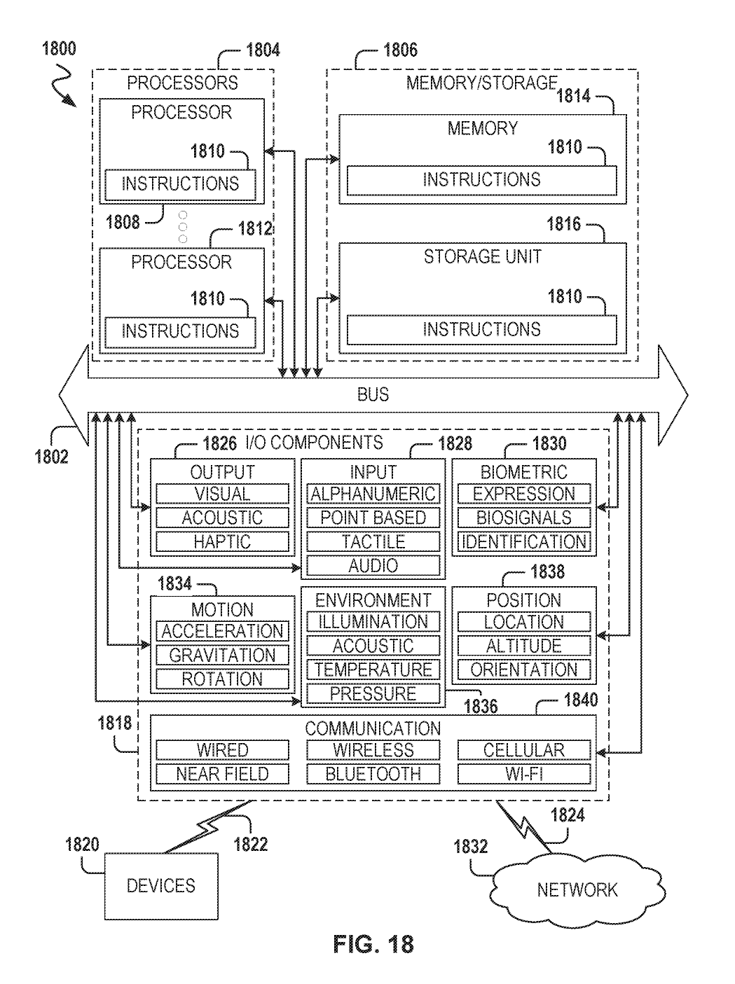

FIG. 17 is a block diagram 1700 illustrating a representative software architecture 1702, which may be used in conjunction with various hardware architectures herein described. FIG. 17 is merely a non-limiting example of a software architecture 1702, and it will be appreciated that many other architectures may be implemented to facilitate the functionality described herein. The software architecture 1702 may be executing on hardware such as a machine 1800 of FIG. 18 that includes, among other things, processors 1804, memory/storage 1806, and input/output (I/O) components 1818. A representative hardware layer 1750 is illustrated and may represent, for example, the machine 1800 of FIG. 18. The representative hardware layer 1750 comprises one or more processing units 1752 having associated executable instructions 1754. The executable instructions 1754 represent the executable instructions of the software architecture 1702, including implementation of the methods, modules, and so forth of FIGS. 1-16. The hardware layer 1750 also includes memory and/or storage modules 1756, which also have the executable instructions 1754. The hardware layer 1750 may also comprise other hardware 1758, which represents any other hardware of the hardware layer 1750, such as the other hardware illustrated as part of the machine 1800.

In the example architecture of FIG. 17, the software architecture 1702 may be conceptualized as a stack of layers where each layer provides particular functionality. For example, the software architecture 1702 may include layers such as an operating system 1720, libraries 1716, frameworks/middleware 1714, applications 1712, and a presentation layer 1710. Operationally, the applications 1712 and/or other components within the layers may invoke application programming interface (API) calls 1704 through the software stack and receive a response, returned values, and so forth illustrated as messages 1708 in response to the API calls 1704. The layers illustrated are representative in nature, and not all software architectures have all layers. For example, some mobile or special-purpose operating systems may not provide a frameworks/middleware 1714 layer, while others may provide such a layer. Other software architectures may include additional or different layers.

The operating system 1720 may manage hardware resources and provide common services. The operating system 1720 may include, for example, a kernel 1718, services 1722, and drivers 1724. The kernel 1718 may act as an abstraction layer between the hardware and the other software layers. For example, the kernel 1718 may be responsible for memory management, processor management (e.g., scheduling), component management, networking, security settings, and so on. The services 1722 may provide other common services for the other software layers. The drivers 1724 may be responsible for controlling or interfacing with the underlying hardware. For instance, the drivers 1724 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1716 may provide a common infrastructure that may be utilized by the applications 1712 and/or other components and/or layers. The libraries 1716 typically provide functionality that allows other software modules to perform tasks in an easier fashion than by interfacing directly with the underlying operating system 1720 functionality (e.g., kernel 1718, services 1722, and/or drivers 1724). The libraries 1716 may include system libraries 1742 (e.g., C standard library) that may provide functions such as memory allocation functions, string manipulation functions, mathematic functions, and the like. In addition, the libraries 1716 may include API libraries 1744 such as media libraries (e.g., libraries to support presentation and manipulation of various media formats such as MPEG4, H.264, MP3, AAC, AMR, JPG, PNG), graphics libraries (e.g., an OpenGL framework that may be used to render two-dimensional and three-dimensional graphic content on a display), database libraries (e.g., SQLite that may provide various relational database functions), web libraries (e.g., WebKit that may provide web browsing functionality), and the like. The libraries 1716 may also include a wide variety of other libraries 1746 to provide many other APIs to the applications 1712 and other software components/modules.

The frameworks 1714 (also sometimes referred to as middleware) may provide a higher-level common infrastructure that may be utilized by the applications 1712 and/or other software components/modules. For example, the frameworks 1714 may provide various graphic user interface (GUI) functions, high-level resource management, high-level location services, and so forth. The frameworks 1714 may provide a broad spectrum of other APIs that may be utilized by the applications 1712 and/or other software components/modules, some of which may be specific to a particular operating system or platform.

The applications 1712 include the HDI manager 125, the report generator 127, and other modules as shown in FIG. 1 (not shown); built-in applications 1736, and third-party applications 1738. Examples of representative built-in applications 1736 may include, but are not limited to, a contacts application, a browser application, a book reader application, a location application, a media application, a messaging application, and/or a game application. The third-party applications 1738 may include any of the built-in applications 1736 as well as a broad assortment of other applications. In a specific example, the third-party application 1738 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 1738 may invoke the API calls 1704 provided by the mobile operating system such as the operating system 1720 to facilitate functionality described herein.

The applications 1712 may utilize built-in operating system functions (e.g., kernel 1718, services 1722, and/or drivers 1724), libraries (e.g., system libraries 1742, API libraries 1744, and other libraries 1746), or frameworks/middleware 1714 to create user interfaces to interact with users of the system. Alternatively, or additionally, in some systems, interactions with a user may occur through a presentation layer, such as the presentation layer 1710. In these systems, the application/module “logic” may be separated from the aspects of the application/module that interact with a user.

Some software architectures utilize virtual machines. In the example of FIG. 17, this is illustrated by a virtual machine 1706. A virtual machine creates a software environment where applications/modules may execute as if they were executing on a hardware machine (such as the machine 1800 of FIG. 18, for example). The virtual machine 1706 is hosted by a host operating system (e.g., the operating system 1720 in FIG. 17) and typically, although not always, has a virtual machine monitor 1760, which manages the operation of the virtual machine 1706 as well as the interface with the host operating system (e.g., the operating system 1720). A software architecture executes within the virtual machine 1706, such as an operating system 1734, libraries 1732, frameworks/middleware 1730, applications 1728, and/or a presentation layer 1726. These layers of software architecture executing within the virtual machine 1706 may be the same as corresponding layers previously described or may be different.

FIG. 18 is a block diagram illustrating components of a machine 1800, according to some example embodiments, able to read instructions from a machine-readable medium (e.g., a machine-readable storage medium) and perform any one or more of the methodologies discussed herein. Specifically, FIG. 18 shows a diagrammatic representation of the machine 1800 in the example form of a computer system, within which instructions 1810 (e.g., software, a program, an application, an applet, an app, or other executable code) for causing the machine 1800 to perform any one or more of the methodologies discussed herein may be executed. For example, the instructions 1810 may cause the machine 1800 to execute the flow diagrams of FIGS. 8, 9, and 16. Additionally, or alternatively, the instructions 1810 may implement the programs of the social networking server 112, and so forth. The instructions 1810 transform the general, non-programmed machine 1800 into a particular machine 1800 programmed to carry out the described and illustrated functions in the manner described.

In alternative embodiments, the machine 1800 operates as a standalone device or may be coupled (e.g., networked) to other machines. In a networked deployment, the machine 1800 may operate in the capacity of a server machine or a client machine in a server-client network environment, or as a peer machine in a peer-to-peer (or distributed) network environment. The machine 1800 may comprise, but not be limited to, a switch, a controller, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1810, sequentially or otherwise, that specify actions to be taken by the machine 1800. Further, while only a single machine 1800 is illustrated, the term “machine” shall also be taken to include a collection of machines 1800 that individually or jointly execute the instructions 1810 to perform any one or more of the methodologies discussed herein.

The machine 1800 may include processors 1804, memory/storage 1806, and I/O components 1818, which may be configured to communicate with each other such as via a bus 1802. In an example embodiment, the processors 1804 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application-Specific Integrated Circuit (ASIC), a Radio-Frequency Integrated Circuit (RFIC), another processor, or any suitable combination thereof) may include, for example, a processor 1808 and a processor 1812 that may execute the instructions 1810. The term “processor” is intended to include multi-core processors that may comprise two or more independent processors (sometimes referred to as “cores”) that may execute instructions contemporaneously. Although FIG. 18 shows multiple processors 1804, the machine 1800 may include a single processor with a single core, a single processor with multiple cores (e.g., a multi-core processor), multiple processors with a single core, multiple processors with multiple cores, or any combination thereof.

The memory/storage 1806 may include a memory 1814, such as a main memory, or other memory storage, and a storage unit 1816, both accessible to the processors 1804 such as via the bus 1802. The storage unit 1816 and memory 1814 store the instructions 1810 embodying any one or more of the methodologies or functions described herein. The instructions 1810 may also reside, completely or partially, within the memory 1814, within the storage unit 1816, within at least one of the processors 1804 (e.g., within the processor's cache memory), or any suitable combination thereof, during execution thereof by the machine 1800. Accordingly, the memory 1814, the storage unit 1816, and the memory of the processors 1804 are examples of machine-readable media.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EPROM)), and/or any suitable combination thereof. The term “machine-readable medium” should be taken to include a single medium or multiple media (e.g., a centralized or distributed database, or associated caches and servers) able to store the instructions 1810. The term “machine-readable medium” shall also be taken to include any medium, or combination of multiple media, that is capable of storing instructions (e.g., instructions 1810) for execution by a machine (e.g., machine 1800), such that the instructions, when executed by one or more processors of the machine (e.g., processors 1804), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1818 may include a wide variety of components to receive input, provide output, produce output, transmit information, exchange information, capture measurements, and so on. The specific I/O components 1818 that are included in a particular machine will depend on the type of machine. For example, portable machines such as mobile phones will likely include a touch input device or other such input mechanisms, while a headless server machine will likely not include such a touch input device. It will be appreciated that the 1/O components 1818 may include many other components that are not shown in FIG. 18. The I/O components 1818 are grouped according to functionality merely for simplifying the following discussion, and the grouping is in no way limiting. In various example embodiments, the 1/O components 1818 may include output components 1826 and input components 1828. The output components 1826 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1828 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 1818 may include biometric components 1830, motion components 1834, environmental components 1836, or position components 1838 among a wide array of other components. For example, the biometric components 1830 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1834 may include acceleration sensor components (e.g., accelerometer), gravitation sensor components, rotation sensor components (e.g., gyroscope), and so forth. The environmental components 1836 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1838 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1818 may include communication components 1840 operable to couple the machine 1800 to a network 1832 or devices 1820 via a coupling 1824 and a coupling 1822, respectively. For example, the communication components 1840 may include a network interface component or other suitable device to interface with the network 1832. In further examples, the communication components 1840 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1820 may be another machine or any of a wide variety of peripheral devices (e.g., a peripheral device coupled via a USB).

Moreover, the communication components 1840 may detect identifiers or include components operable to detect identifiers. For example, the communication components 1840 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code. Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1840, such as location via Internet Protocol (IP) geo-location, location via Wi-Fi® signal triangulation, location via detecting an NFC beacon signal that may indicate a particular location, and so forth.

In various example embodiments, one or more portions of the network 1832 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1832 or a portion of the network 1832 may include a wireless or cellular network and the coupling 1824 may be a Code Division Multiple Access (CDMA) connection, a Global System for Mobile communications (GSM) connection, or another type of cellular or wireless coupling. In this example, the coupling 1824 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 1810 may be transmitted or received over the network 1832 using a transmission medium via a network interface device (e.g., a network interface component included in the communication components 1840) and utilizing any one of a number of well-known transfer protocols (e.g., hypertext transfer protocol (HTTP)). Similarly, the instructions 1810 may be transmitted or received using a transmission medium via the coupling 1822 (e.g., a peer-to-peer coupling) to the devices 1820. The term “transmission medium” shall be taken to include any intangible medium that is capable of storing, encoding, or carrying the instructions 1810 for execution by the machine 1800, and includes digital or analog communications signals or other intangible media to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
determining, by one or more processors, job metrics for a global pool of users, the job metrics being based on job-post communications received by the users in the global pool of users;
receiving, by the one or more processors, filters for generating a report, the filters being applied to the global pool of users based on user profile data;
identifying, by the one or more processors, a talent pool based on the received filters;
determining, by the one or more processors, a talent-pool metric based on the job-post communications received by the users in the talent pool;
determining, by the one or more processors, a hiring demand index based on the talent-pool metric and the job metrics for the global pool of users, the hiring demand index providing a degree of difficulty for hiring users from the talent pool; and
causing, by the one or more processors, presentation of the report, the report including the hiring demand index for the talent pool.

2. The method as recited in claim 1, wherein the job metrics comprise a number of communications received from recruiters by the user regarding job posts.

3. The method as recited in claim 1, wherein the job metrics are selected from a group comprising number of communications received from recruiters, number of job posts associated with the talent pool, number of recruiters contacting users in the talent pool, and number of companies communicating with the talent pool regarding job posts.

4. The method as recited in claim 1, wherein the job metrics are selected from a group comprising a degree of success of a company hiring from the talent pool, salary data for the talent pool, amount of time job posts associated with the talent pool are open, a bid price for job posts targeted to the talent pool, and a number of paid job postings targeting the talent pool.

5. The method as recited in claim 1, wherein the talent-pool metric comprises an average number of communications received by users in the talent pool, within a predetermined time period, regarding job posts.

6. The method as recited in claim 1, wherein determining the job metrics further comprises:
calculating percentiles for a number of communications received from recruiters by a user regarding job posts; and
determining a plurality of classes based on the percentiles.

7. The method as recited in claim 6, wherein the talent-pool metric is an average number of communications received, within a predetermined time period, by users in the talent pool regarding job posts, wherein determining the hiring demand index further comprises:
selecting a class from the plurality of classes based on the talent-pool metric.

8. The method as recited in claim 1, wherein the filters include one or more of a geographic location and a job skill.

9. The method as recited in claim 1, wherein the report includes a number of users in the talent pool based on the filters, a number of job posts targeted to the talent pool, geographic information about the talent pool, and the hiring demand index.

10. The method as recited in claim 1, wherein the job metrics comprise a number of communications received by a user regarding job posts.

11. A system comprising:
a memory comprising instructions; and
one or more computer processors, wherein the instructions, when executed by the one or more computer processors, cause the one or more computer processors to perform operations comprising:
determining job metrics for a global pool of users, the job metrics being based on job-post communications received by the users in the global pool of users;
receiving filters for generating a report, the filters being applied to the global pool of users based on user profile data;
identifying a talent pool based on the received filters;
determining a talent-pool metric based on the job-post communications received by the users in the talent pool;
determining a hiring demand index based on the talent-pool metric and the job metrics for the global pool of users, the hiring demand index providing a degree of difficulty for hiring users from the talent pool; and
causing presentation of the report, the report including the hiring demand index for the talent pool.

12. The system as recited in claim 11, wherein the job metrics comprise a number of communications received from recruiters by the users regarding job posts.

13. The system as recited in claim 11, wherein the job metrics are selected from a group comprising number of communications received from recruiters, number of job posts associated with the talent pool, number of recruiters contacting users in the talent pool, and number of companies communicating with the talent pool regarding job posts.

14. The system as recited in claim 11, wherein the job metrics are selected from a group comprising a degree of success of a company hiring from the talent pool, salary data for the talent pool, amount of time job posts associated with the talent pool are open, a bid price for job posts targeted to the talent pool, and a number of paid job postings targeting the talent pool.

15. The system as recited in claim 11, wherein the talent-pool metric comprises an average number of communications received by users in the talent pool, within a predetermined time period, regarding job posts.

16. A non-transitory machine-readable storage medium including instructions that, when executed by a machine, cause the machine to perform operations comprising:
determining job metrics for a global pool of users, the job metrics being based on job-post communications received by the users in the global pool of users;
receiving filters for generating a report, the filters being applied to the global pool of users based on user profile data;
identifying a talent pool based on the received filters;
determining a talent-pool metric based on the job-post communications received by the users in the talent pool;
determining a hiring demand index based on the talent-pool metric and the job metrics for the global pool of users, the hiring demand index providing a degree of difficulty for hiring users from the talent pool; and
causing presentation of the report, the report including the hiring demand index for the talent pool.

17. The machine-readable storage medium as recited in claim 16, wherein the job metrics comprise a number of communications received from recruiters by the users regarding job posts.

18. The machine-readable storage medium as recited in claim 16, wherein the job metrics are selected from a group comprising number of communications received from recruiters, number of job posts associated with the talent pool, number of recruiters contacting users in the talent pool, and number of companies communicating with the talent pool regarding job posts.

19. The machine-readable storage medium as recited in claim 16, wherein the job metrics are selected from a group comprising a degree of success of a company hiring from the talent pool, salary data for the talent pool, amount of time job posts associated with the talent pool are open, a bid price for job posts targeted to the talent pool, and a number of paid job postings targeting the talent pool.

20. The machine-readable storage medium as recited in claim 16, wherein the talent-pool metric comprises an average number of communications received by users in the talent pool, within a predetermined time period, regarding job posts.
